(19) United States
(12) Patent Application Publication
(10) Pub. No.: US 2009/0307947 A1
(43) Pub. Date: Dec. 17, 2009

(54) Display System

(75) Inventor: Ryohei KONO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/237,040

(22) Filed: Sep. 24, 2008

Related U.S. Application Data
(60) Provisional application No. 61/061,815, filed on Jun. 16, 2008.

(51) Int. Cl. G09F 19/00

(52) U.S. Cl. 40/406

(57) ABSTRACT

A slot machine according to the present embodiment executes a slot game in which symbols being arranged are rearranged in plural segmented areas provided on an LCD in a matrix arrangement with first to fifth columns aligned laterally and first to third rows aligned vertically. An image is simultaneously displayed on a bubble display provided in front of the LCD by bubbles generated in liquids filled in plural tubes in case where the rearranged symbols has achieved a winning combination on a activated payline. For example, the bubble image displayed on the bubble display may be a belt. This belt has a width so as to cover a single row extending from the first to five columns. Symbols in each of the rows on the LCD are stopped sequentially to be displayed in synchronization with a floating timing of the bubble belt in the liquids.

### BACKGROUND OF THE INVENTION

1. Field of the Invention

The present invention relates to a display system for allowing a user to view an image displayed on a rear display transmissively through an image displayed on a front display.

2. Description of Related Art

In a slot machine described in Japanese Patent Application Laid-open No. 2006-141634, a liquid crystal display device and a bubble display are parallely located in front of reels. Image effects displayed on the liquid crystal display device and overlaid with some symbols on the reels can be seen by a player, while other symbols on the reels are masked from the player's view by bubbles generated on the bubble display.

The bubble display can be used to display images such as characters, as described in Japanese Patent Application Laid-open Nos. 7-20807, 9-265268, 2004-264383 and 2005-143546.

Uniformity and clarity of images displayed on the bubble display can be enhanced by employing a configuration described in WO 2004/077389, US 2006/0238,659 A1, or EP 1,598,797 A1.

### SUMMARY OF THE INVENTION

The present invention provides a display system having a front display provided in front of a rear display and capable of preventing visibility degradation of images displayed on the rear display due to existence of the front display in case where allowing a user to view an image displayed on the rear display transmissively through an image displayed on the front display.

A first aspect of the present invention provides a display system which includes
a rear display capable of displaying a plurality of symbols laterally;
a front display provided in front of the rear display and including:
   (a) a plurality of transparent tubes extending vertically and aligned laterally,
   (b) liquids filled in the plural of tubes, respectively, and
   (c) a plurality of bubble generating nozzles provided at bottoms of the tubes, respectively, for generating bubbles to emerge in the liquids in the plurality of tubes, respectively;
a plurality of air on-off valves connected to the plurality of bubble generating nozzles, respectively;
an air pump connected to each of the plurality of air on-off valves; and
a controller operable to control opening and closing of the plurality of air on-off valves, respectively, in a pattern according to a prescribed image that is displayed on the front display by the bubbles in the liquids in the plurality of tubes and associated with contents of the plurality of symbols displayed on the rear display.

A second aspect of the present invention provides a display system which includes
a rear display capable of shifting vertically and stopping a plurality of symbols aligned laterally to rearrange the symbols had been arranged thereon;
a front display provided in front of the rear display and including:
   (a) a plurality of transparent tubes extending vertically and aligned laterally,
   (b) liquids filled in the plural of tubes, respectively, and
   (c) a plurality of bubble generating nozzles provided at bottoms of the tubes, respectively, for generating bubbles to emerge in the liquids in the plurality of tubes, respectively;
a plurality of air on-off valves connected to the plurality of bubble generating nozzles, respectively;
an air pump connected to each of the plurality of air on-off valves; and
a controller operable to control opening and closing of the plurality of air on-off valves, respectively, in a pattern according to a prescribed image that is displayed on the front display by the bubbles in the liquids in the plurality of tubes and associated with contents of the plurality of symbols rearranged on the rear display.

A third aspect of the present invention provides a display system which includes
a rear display capable of displaying information on a progressive bonus using a plurality of symbols aligned laterally thereon, some of a credit amount that had been bet on a unit game at each of a plurality of slot game machines being accumulated for the progressive bonus;
a front display provided in front of the rear display and including:
   (a) a plurality of transparent tubes extending vertically and aligned laterally,
   (b) liquids filled in the plural of tubes, respectively, and
   (c) a plurality of bubble generating nozzles provided at bottoms of the tubes, respectively, for generating bubbles to emerge in the liquids in the plurality of tubes, respectively;
a plurality of air on-off valves connected to the plurality of bubble generating nozzles, respectively;
an air pump connected to each of the plurality of air on-off valves; and
a controller operable to control opening and closing of the plurality of air on-off valves, respectively, in a pattern according to a prescribed image that is displayed on the front display by the bubbles in the liquids in the plurality of tubes and associated with contents of the information displayed on the rear display.

### BRIEF DESCRIPTION OF THE DRAWINGS

FIG. 1 is an explanatory diagram illustrating a schematic configuration of a display unit of a slot machine according to a first embodiment of the present invention;

FIG. 2 is a perspective view of the slot machine according to the first embodiment of the present invention;

FIG. 3 is an explanatory diagram illustrating matrix-like, segmented areas provided on a display of the slot machine according to the first embodiment of the present invention;

FIG. 4 is an explanatory diagram illustrating paylines which can be set in the matrix-like, segmented areas provided on the display the slot machine according to the first embodiment of the present invention;

FIG. 5 is a block diagram illustrating a control circuit of the slot machine according to the first embodiment of the present invention;

FIG. 6 is an explanatory diagram illustrating a display example of an image on a bubble display of FIG. 1;

FIG. 7 is an explanatory diagram illustrating a display example of an image on the bubble display of FIG. 1;

FIG. 8 is an explanatory diagram illustrating a display example of an image on the bubble display of FIG. 1;

FIG. 9 is an explanatory diagram illustrating a display example of an image on the bubble display of FIG. 1;

FIG. 10 is an explanatory diagram illustrating a display example of an image on the bubble display of FIG. 1;

FIG. 11 is an explanatory diagram illustrating a display example of an image on the bubble display of FIG. 1;

FIG. 12 is an explanatory diagram illustrating a display example of an image on the bubble display of FIG. 1;

FIG. 13 is a flow chart illustrating a processing procedure of the slot machine according to the first embodiment of the present invention;

FIG. 14 is an explanatory diagram illustrating another display example of an image on the bubble display of FIG. 1;

FIG. 15 is an explanatory diagram illustrating a schematic configuration of a main part of a bubble display of a slot machine according to a second embodiment of the present invention;

FIG. 16 is a block diagram illustrating a control circuit of the slot machine according to the second embodiment of the present invention;

FIG. 17 is an explanatory diagram illustrating a display example of an image on the bubble display of the slot machine according to the second embodiment of the present invention;

FIG. 18 is an explanatory diagram illustrating a display example of an image on the bubble display of the slot machine according to the second embodiment of the present invention;

FIG. 19 is an explanatory diagram illustrating a display example of an image on the bubble display of the slot machine according to the second embodiment of the present invention;

FIG. 20 is a perspective view illustrating a spinning reel device of a slot machine according to a third embodiment of the present invention;

FIG. 21 is an explanatory diagram illustrating a schematic configuration of a slot machine system according to a fourth embodiment of the present invention;

FIG. 22 is an explanatory diagram illustrating a schematic configuration of a common display unit of FIG. 21;

FIG. 23 is an enlarged explanatory diagram schematically illustrating a main part of the common display unit of FIG. 22;

FIG. 24 is a block diagram illustrating a control circuit of the slot machine system according to the fourth embodiment of the present invention;

FIG. 25 is a flow chart illustrating a processing procedure by a control circuit of FIG. 24; and

FIG. 26 is an explanatory diagram illustrating a display example of an image by the common display unit of FIG. 22.

### DETAILED DESCRIPTION OF THE EMBODIMENT

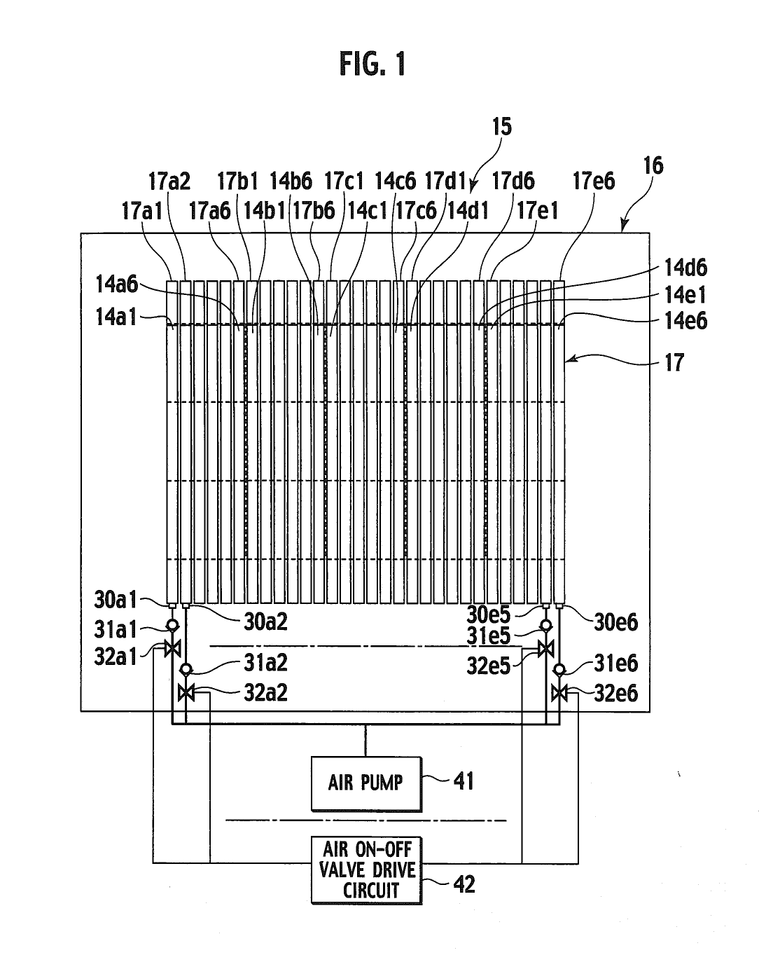

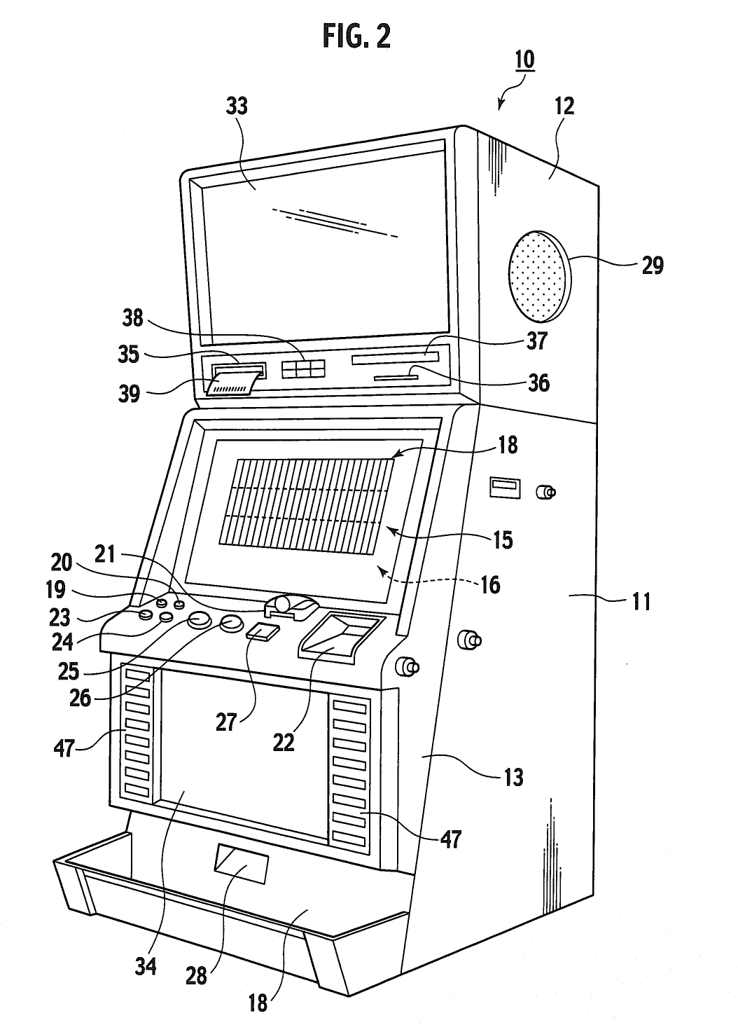

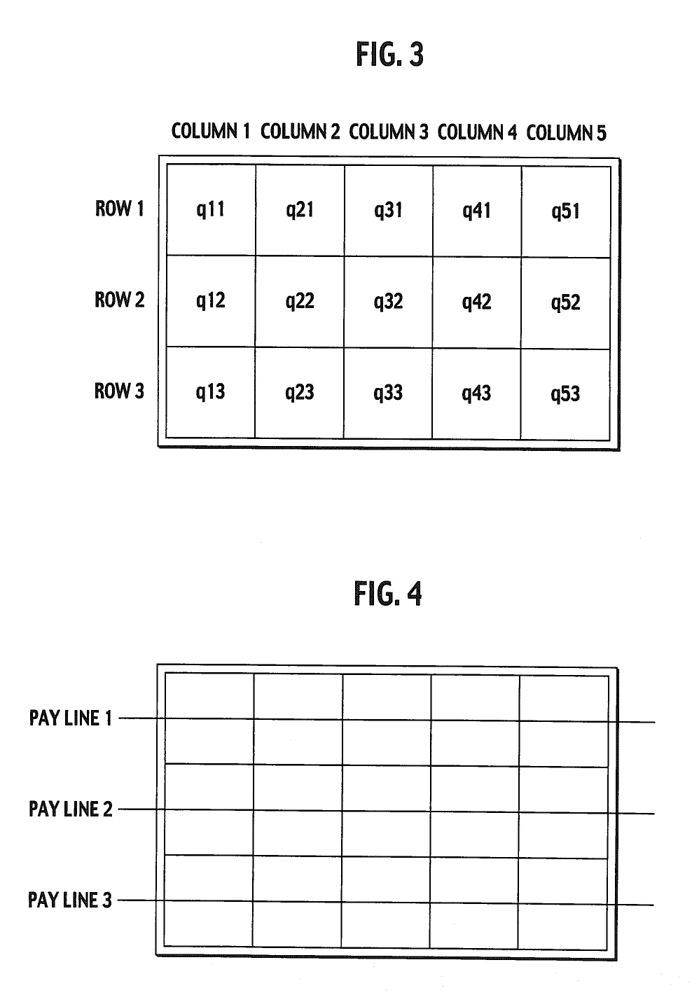

Hereinafter, an embodiment of a slot machine according to the present invention which employs a display system according to the present invention will be described with reference to an explanatory diagram of a display of the slot machine according to a first embodiment shown in FIG. 1, a perspective view of the slot machine according to the first embodiment shown in FIG. 2 and an explanatory diagram of segmented areas, in which the symbols are rearranged, of the slot machine according to the first embodiment shown in FIG. 3.

With the slot machine according to the first embodiment of the present invention, a player can play one slot game (corresponding to a unit game in claims) by betting game media. In the slot game, symbols are displayed using a display unit 15 (corresponding to a display system in the claims) of the slot machine 10 shown in FIG. 2. The display unit 15 has, as shown in FIG. 1, a liquid crystal display 16 (corresponding to a rear display in the claims) and a bubble display 17 (corresponding to a front display in the claims) provided in front of the LCD 16.

The LCD 16 has, as shown in FIG. 3, fifteen segmented areas q11 to q53. Symbols had been arranged are rearranged in the segmented areas q11 to q53. These segmented areas q11 to q53 are provided in a matrix arrangement with first to fifth columns aligned laterally and first to third rows aligned vertically.

A bet of game media can be placed on a slot game according to player's operation of a max-bet button 24, a bet button 25 or a spin/repeat-bet button 26 of the slot machine 10 shown in FIG. 2. Specifically, a bet of game media can be placed on a slot game by allocating restricted credits, which are electronically stored in the slot machine 10 and continuously usable as game media until they are changed into cash, to the bet by an amount specified by the player's operation of any of the buttons 24, 25 or 26.

Note that the above-mentioned credits can be made stored in the slot machine 10 by player's inserting medals, which are cashable credits, into the slot machine 10.

In the following description, unit of game media, which can be placed as a bet using the above-mentioned cashable credits or restricted credits, will be referred to as “credit”.

As shown in FIG. 4, there are three paylines, i.e. upper, middle and lower, on the segmented areas q11 to q53. The paylines to be activated in a slot game vary according to a credit amount had been bet on a slot game by a player. The player can obtain a payout in the slot game if a winning combination(s) has been achieved on the activated payline(s) by symbols rearranged in the segmented areas q11 to q53.

The LCD 16 has a margin around the segmented areas q11 to q53, as shown in FIG. 1. Image effects or the like other than the symbols can be displayed on the marginal area on the LCD 16.

As shown in FIG. 1, the bubble display 17 provided in front of the LCD 16 has plural transparent elongated tubes 17a1 to 17e6, bubble generating nozzles 30a1 to 30e6 respectively corresponding to the tubes 17a1 to 17e6, check valves 31a1 to 31e6, air on-off valves 32a1 to 32e6 and an air pump 41.

Each of the tubes 17a1 to 17e6 has a hollow shape being penetrated in its longitudinal direction. The longitudinal direction of the tubes 17a1 to 17e6 coincides with an alignment direction of the first to third rows (vertical direction) of the segmented areas q11 to q53 on the LCD 16 shown in FIG. 3. In other words, the tubes 17a1 to 17e6 shown in FIG. 1 are aligned along an alignment direction of the first to fifth columns (lateral direction) of the segmented areas q11 to q53 shown in FIG. 3.

Each upper end of the tubes 17a1 to 17e6 is open, and each inside of the tubes 17a1 to 17e6 is filled with transparent and colorless liquid 14a1 to 14e6 up to a position slightly lower than each upper end of the tubes 17a1 to 17e6.

The tubes 17a1 to 17e6 are provided in five sets of six each. Each set of six tubes 17a1 to 17a6, 17b1 to 17b6, 17c1 to 17c6, 17d1 to 17d6 and 17e1 to 17e6 corresponds to each of the first to fifth columns of the segmented areas q11 to q53 shown in FIG. 3. The number of tubes 17a1 to 17e6 to be provided corresponding to each column may be set to a number other than six in accordance with resolution of an image to be displayed on the bubble display 17.

The liquids 14a1 to 14a6 of the first set of tubes 17a1 to 17a6 shown in FIG. 1 cover the three segmented areas q11 to q13 of the first column (see FIG. 3). Similarly, the liquids 14b1 to 14b6, 14c1 to 14c6, 14d1 to 14d6 and 14e1 to 14e6 in the second to fifth sets of the tubes 17b1 to 17b6, 17c1 to 17c6, 17d1 to 17d6 and 17e1 to 17e6 cover the three segmented areas of the second to fifth columns q21 to q23, q31 to q33, q41 to q43 and q51 to q53, respectively (see FIG. 3).

As shown in FIG. 1, each of the bubble generating nozzles 30a1 to 30e6 is connected to each corresponding bottom (lower end) of the tubes 17a1 to 17e6. Each of the air on-off valves 32a1 to 32e6 is connected to each of the bubble generating nozzles 30a1 to 30e6 via each of the check valves 31a1 to 31e6. The liquids 14a1 to 14e6 in the tubes 17a1 to 17e6 do not flow into the air on-off valves 32a1 to 32e6 through the check valves 31a1 to 31e6.

The air on-off valves 32a1 to 32e6 are connected to the air pump 41. In addition, opening and closing of each of the air on-off valves 32a1 to 32e6 is driven by an air on-off valve drive circuit 42. Air supplied by the air pump 41 is sent into each of the bubble generating nozzles 30a1 to 30e6 through each of the check valves 31a1 to 31e6 while the air on-off valves 32a1 to 32e6 are made open.

The bubble generating nozzles 30a1 to 30e6 diffuse the air supplied from the air pump 41 into bubbles and inject them into the liquids 14a1 to 14e6 of the corresponding tubes 17a1 to 17e6. The injected bubbles float upward in the liquids 14a1 to 14e6 in the tubes 17a1 to 17e6. The liquids 14a1 to 14e6 never overflow from the tubes 17a1 to 17e6 due to rises of liquid levels by injection of the bubbles.

Detailed configurations of the bubble generating nozzles 30a1 to 30e6 for injecting bubbles into the liquids 14a1 to 14e6 of the tubes 17a1 to 17e6 may take configurations described in WO 2004/077389, US 2006/238,659 A1 or EP 1598797 A1, for example.

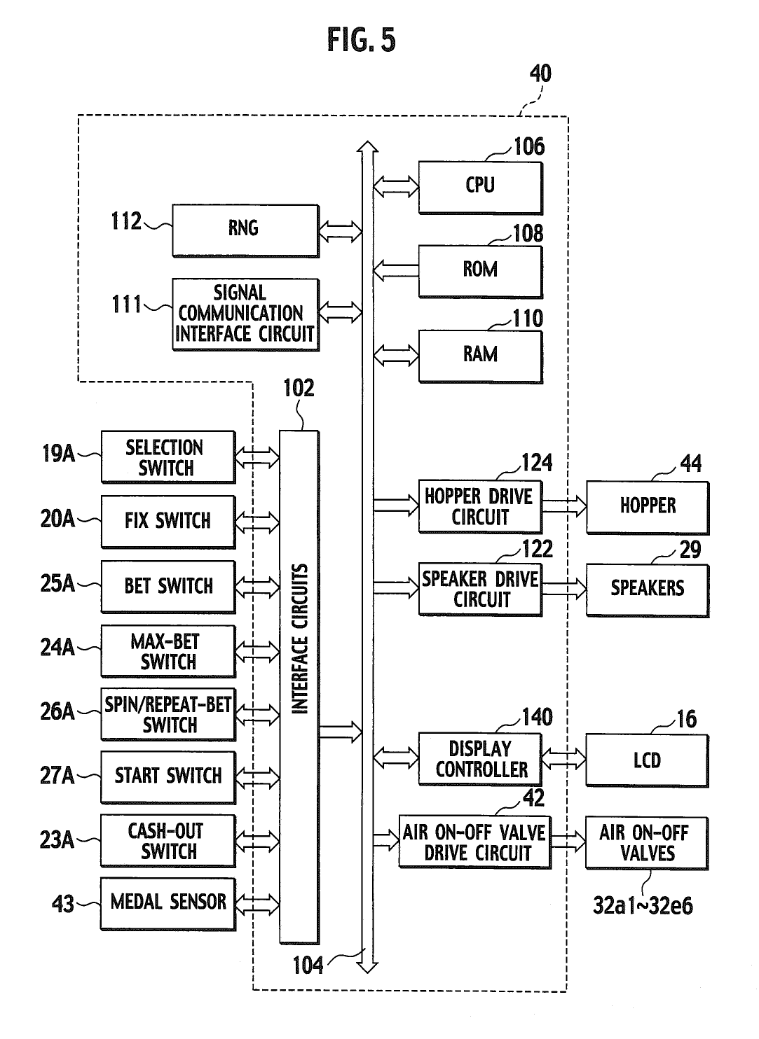

In the display unit 15 of the slot machine 10 according to the first embodiment, opening and closing of the air on-off valves 32a1 to 32e6 are driven by the air on-off valve drive circuit 42 in a pattern according to a predetermined image corresponding to symbols to be rearranged in the segmented areas q11 to q53 on the LCD 16. Opening and closing drive of the air on-off valves 32a1 to 32e6 by the air on-off valve drive circuit 42 is controlled by a controller 40 shown in FIG. 5.

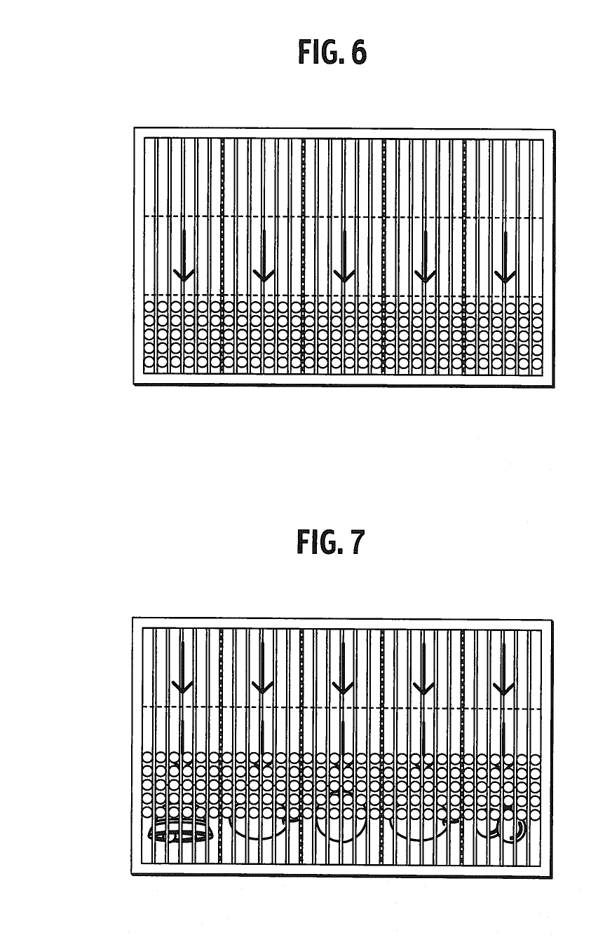

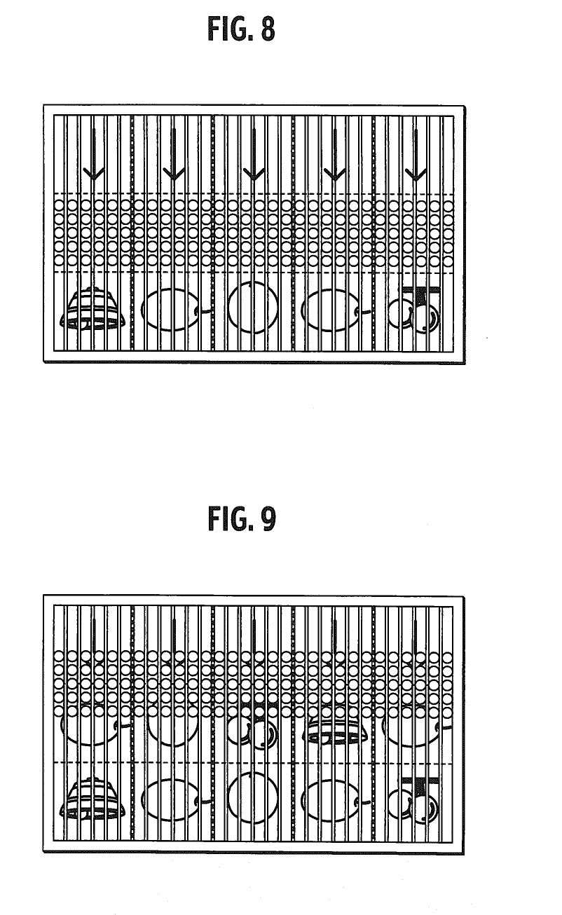

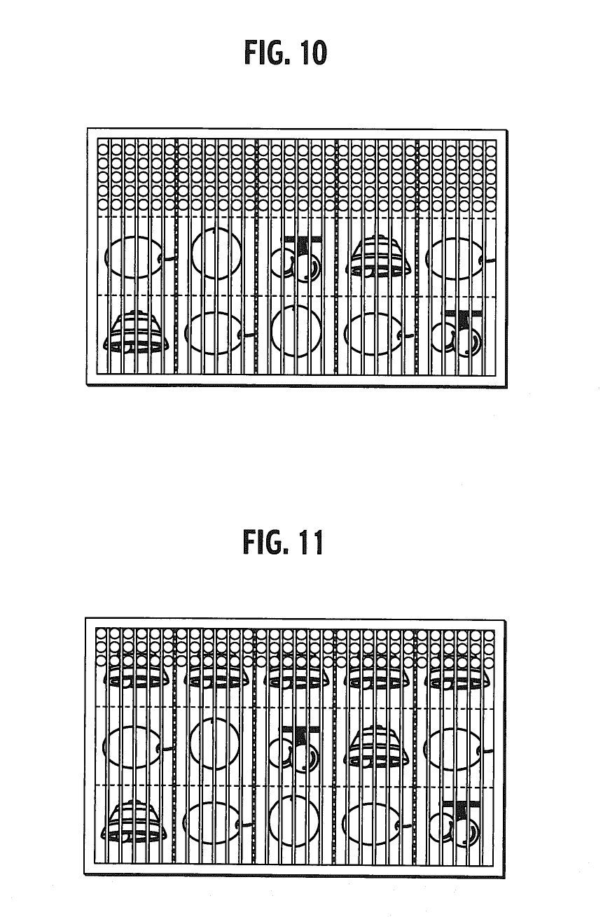

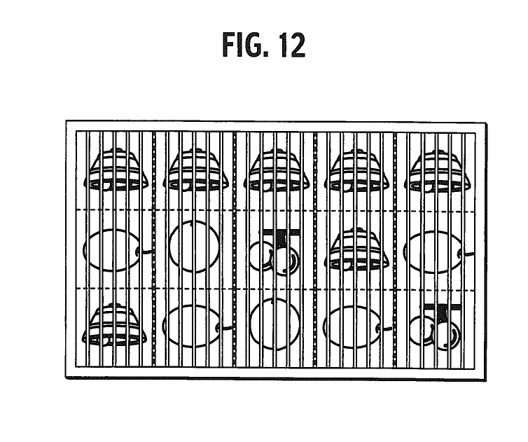

As shown in an explanatory diagrams of FIGS. 6 to 12, for example, bubbles covering one row along entire of the first to fifth columns can be injected into the liquids 14a1 to 14e6 in the tubes 17a1 to 17e6 by intermittently opening and closing the air on-off valves 32a1 to 32e6, which are normally closed, for a while. According to these bubbles, a belt of bubbles covering one row moving from the bottom to the top of the tubes 17a1 to 17e6 is displayed on the bubble display 17.

Then, in the case where rearrangement of symbols in the segmented areas q11 to q53 on the LCD 16 is sequentially made in three stages such as the five segmented areas q13 to q53 of the third row, the five segmented areas q12 to q52 of the second row and the five segmented areas q11 to q51 of the first row, an effective presentation can be made in which each row of the segmented areas q13 to q53, q12 to q52 and q11 to q51 before symbol rearrangement has not been finished yet is temporarily masked by the bubbles displayed on the bubble display 17.

According to the slot machine 10 of the present embodiment, a player (corresponding to a user in the claims) can view symbols rearranged (displayed) in the segmented areas q11 to q53 on the LCD 16 through the transparent tubes 17a1 to 17e6 of the bubble display 17 and the transparent and colorless liquids 14a1 to 14e6 therein, even if a bubble image cannot be displayed on the bubble display 17 due to an electrical outage or a malfunction of the bubble display 17, the air on-off valve drive circuit 42, the controller 40 or the like. In other words, visibility of symbols displayed on the LCD 16 cannot be disturbed even if the bubble display 17 is interpositioned.

Next, the configuration of the slot machine 10 according to the first embodiment of the present invention will be described in detail. As shown in FIG. 2, the slot machine 10 according to the first embodiment includes a cabinet 11, a top box 12 provided on the top of the cabinet and a main door 13. The main door 13 is attached to the cabinet 11 so that it can be opened or closed. Some elements of the display unit 15 are provided on a surface of the main door 13 facing a player. In addition, other elements of the display unit 15, the controller 40 for electrically controlling the slot machine 10 (see FIG. 5) and various components including a hopper 44 (see FIG. 5) for controlling insertion, accumulation and payout of medals are provided within the cabinet 11.

In addition, although an example is explained in the first embodiment in which a bet required to play a game is placed using medals, a bet on a game can be placed using cashable credits such as coins or tokens other than medals mentioned above. A bet on a game can also be placed using restricted credits such as electronic money or electronic value information corresponding thereto, which are electronically stored in the slot machine 10 and continuously usable as game media until they are changed into cash. A credit amount for a bet on the slot game using these game media can be arbitrarily determined by a player.

The display unit 15 has the LCD 16 and the bubble display 17. As described later, the LCD 16 displays images relating to various games including a slot game. In a slot game, as shown in FIG. 3, symbols, which had been arranged in the fifteen segmented areas q11 to q53 provided in a matrix including the first to fifth columns and the first to third rows, are sequentially changed and then rearranged.

As shown in FIG. 4, there are three paylines, i.e. upper, middle and lower, on the segmented areas q11 to q53. The paylines to be activated in a slot game vary according to a credit amount had been bet on a slot game by a player.

The player can obtain a payout in the slot game if a winning combination(s) has been achieved on the activated payline(s) by symbols rearranged in the segmented areas q11 to q53. In the first embodiment, an award according to the achieved winning combination is provided by increasing an amount of restricted credits stored in the slot machine 10 as described later in detail. The amount of restricted credits stored is displayed on the LCD 16 as described later.

As shown in FIG. 2, a medal insertion slot 21 for inserting medal(s) to place a bet with credits on a slot game and a bill validator 22 for validating bills and accepting valid bills are provided below the display unit 15. In addition, various operation buttons are provided nearby the medal insertion slot 21 and the bill validator 22.

The payout button 23, the max-bet button 24, the bet button 25, the spin/repeat-bet button 26 and a start button 27 are provided as the operation buttons.

The bet button 25 is a button for determining a credit amount to be bet at placing a bet with credits on a slot game to be executed on the display unit 15. One credit will be bet at each press of the bet button 25.

The max-bet button 24 is a button for placing a bet with maximum credits for a single slot game betting by only one operation. Here, the maximum credits to be bet on a single slot game can be changed by an administrator's operation.

The spin/repeat-bet button 26 is a button which is operated by the player when setting a credit amount to be bet on the current slot game equivalent to that on the previous game. Operating the spin/repeat-bet button 26 allows the same credit amount as that for the previous slot game to be bet on the current game without re-operating the max-bet button 24 or the bet button 25 for setting a credit amount to be bet on the current slot game.

The start button 27 is a button for starting a slot game on the display unit 15 after placing a bet on the slot game. When the start button 27 is pressed after placing a bet on the current slot game, symbols are displayed with being changed sequentially in the segmented areas q11 to q53 on the LCD 16 and subsequently the symbols are rearranged.

The payout button 23 is a button for exchanging the stored number of restricted credits displayed on the LCD 16 into medals to cash them out. The medals to be cashed out are ejected from a medal cash-out chute 28 opened at a lower part of the front face of the main door 13 and the cashed-out medals are accumulated on a medal tray 18.

A foot display 34 is provided at the lower front face of the main door 13 for displaying various images relating to a slot game. For example, the images may include characters of a slot game to be played on the slot machine 10.

Lamps 47 are provided on both sides of the foot display 34 for emitting light according to a predetermined light emission pattern. The above-mentioned medal cash-out chute 28 is provided below the foot display 34.

An upper display 33 is provided on a front face of the top box 12. The upper display 33 shows the number of medals to be paid out corresponding to each symbol combination and image effects.

In addition, speakers 29 are provided on the top box 12. A ticket printer 35, a card reader 36, a data display 37 and a keypad 38 are provided below the upper display 33. The ticket printer 35 prints a bar code containing encoded data such as a credit amount, time and date and an ID number of the slot machine 10 on a ticket and then outputs it as a bar-coded ticket 39.

The player can play at another slot machine using the bar-coded ticket 39 or exchange the bar-coded ticket 39 into bills or the like at a predetermined spot in a game arcade (for example, cashier in a casino).

A smart card can be inserted into the card reader 36 and the card reader 36 reads data from and writes data into the inserted smart card. The smart card is carried by a player and stores data for identifying the player, data relating to a game history played by the player and so on. Note that it may be employed such that a maximum bet amount on a single slot game can be changed based on data stored in a smart card and read out by the card reader 36. Changing the maximum bet amount in such a manner is of service for high roller players.

FIG. 5 is a block diagram illustrating an electrical configuration of the controller 40 and various components connected to the controller 40 provided in the slot machine 10 according to the first embodiment. The controller 40 of the slot machine 10 shown in FIG. 5 is a microcomputer and includes interface circuits 102, an I/O bus 104, a CPU 106, a ROM 108, a RAM 110, a communication interface circuit 111, a random number generator 112, a speaker drive circuit 122, a hopper drive circuit 124, a display controller 140 and the above-mentioned air on-off valve drive circuit 42 (see FIG. 1).

The interface circuits 102 are connected to the I/O bus 104 and the I/O bus 104 transmits data signals or address signals with the CPU 106.

A start switch 27A for detecting operations on the start button 27 is connected to the interface circuits 102. A start signal output from the start switch 27A is sent to the CPU 106 via the I/O bus 104 after being converted into a predetermined signal in the interface circuits 102.

Furthermore, a bet switch 25A for detecting operations on the bet button 25, a max-bet switch 24A for detecting operations on the max-bet button 24, a spin/repeat-bet switch 26A for detecting operations on the spin/repeat-bet button 26 and a payout switch 23A for detecting operations on the payout button 23 are connected to the interface circuits 102. Each switching signal output from the switches 25A, 24A, 26A and 23A is provided to the interface circuits 102 and sent to the CPU 106 via the I/O bus 104 after having been converted into a predetermined signal in the interface circuits 102.

In addition, a medal sensor 43 is connected to the interface circuits 102. The medal sensor 43 is a sensor for detecting medals inserted into the medal insertion slot 21 and provided at a medal insertion point of the medal insertion slot 21. A detection signal output from the medal sensor 43 is provided to the interface circuits 102 and sent to the CPU 106 via the I/O bus 104 after being converted into a predetermined signal by the interface circuits 102.

The ROM 108 for storing system programs and the RAM 110 for storing a variety of data are connected to the I/O bus 104. Furthermore, the RNG 112, the communication interface circuit 111, the display controller 140, the hopper drive circuit 124, the speaker drive circuit 122, a lamp drive circuit 126 and the air on-off valve drive circuit 42 are connected to the I/O bus 104.

The CPU 106 reads game execution programs to execute a slot game upon being triggered by an acceptance of a game start operation due to a signal input from the start switch 27A associated with a player's operation of the start button 27. The game execution programs are programs for executing a slot game on the display unit 15 with an interposition of the display controller 140 and the air on-off valve drive circuit 42.

Specifically, the game execution programs scroll symbols in the segmented areas q11 to q53 on the LCD 16 (see FIG. 3) and then stop symbols in order to rearrange symbols which had been arranged. It is programmed so that a payout for an award is provided in case where rearranged symbols have brought a winning combination(s) on an activated payline(s). In addition, the game execution programs are programmed to display, as appropriate, bubble images on the bubble display 17 in synchronization with rearranging symbols on the LCD 16.

The communication interface circuit 111 is connected to a hall server or the like and sends playing history data of the slot machine 10 or the like to the hall server. It also receives a variety of data sent from the hall server.

The RNG 112 generates random numbers for determining whether or not to generate a winning combination(s) on an activated payline (s) in a slot game executed on the display unit 15.

The speaker drive circuit 122 outputs audio data to the speakers 29. Specifically, the CPU 106 reads out audio data stored in the ROM 108 and sends the audio data to the speaker drive circuit 122 via the I/O bus 104 to make a predetermined sound effect output from the speakers 29.

The hopper drive circuit 124 outputs a payout signal to the hopper 44 when a payout is to be made. Specifically, when the payout button 23 has been operated by a player and a payout signal from the payout switch 23A has been input into the CPU 106, the CPU 106 outputs a drive signal to the hopper drive circuit 124 via the I/O bus 104. In response, the hopper 44 cashes out medals corresponding to an amount of currently remaining restricted credits which is stored in a predetermined memory area in the RAM 110 and displayed on the LCD 16.

The air on-off valve drive circuit 42 controls the bubble display 17 with respect to a display control of a slot game executed on the display unit 15. Specifically, the CPU 106 generates an image display command signal according to a slot game status or result and outputs the image display command signal to the air on-off valve drive circuit 42 via the I/O bus 104. The air on-off valve drive circuit 42 generates a drive signal for driving the bubble display 17 of the display unit 15 based on the image display command to output the generated drive signal to the air on-off valves 32a1 to 32e6 of the bubble display 17 upon receiving the image display command signal from the CPU 106.

The display controller 140 controls the LCD 16 with respect to the display control of a slot game executed on the display unit 15. Specifically, the CPU 106 generates the image display command signal according to a slot game status or result and outputs the image display command signal to the display controller 140 via the I/O bus 104. The display controller 140 generates a drive signal for driving the LCD 16 of the display unit 15 based on the image display command to output the generated drive signal to the LCD 16 upon receiving the image display command signal from the CPU 106.

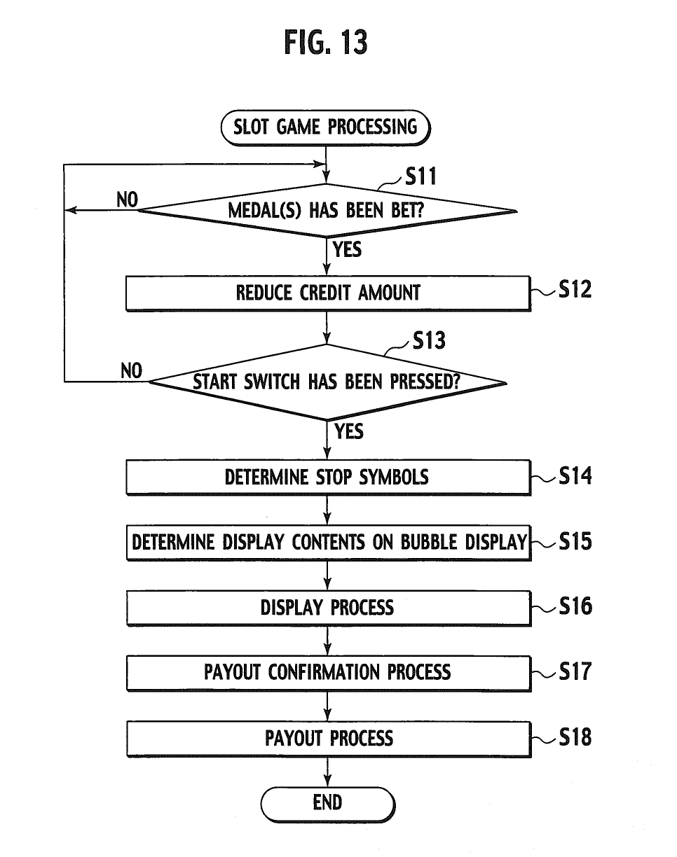

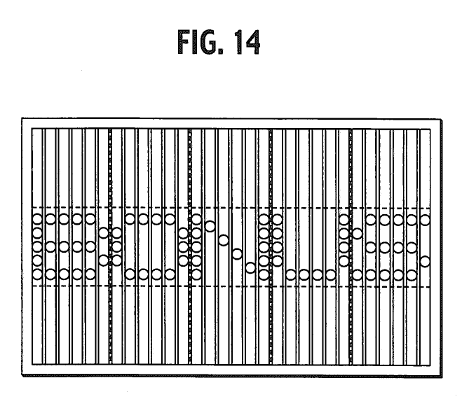

Next, processing procedures of a game execution at the slot machine 10 as a gaming machine according to the first embodiment of the present invention will be described with reference to a flow chart shown in FIG. 13.

Next, operations of the slot machine according to the present embodiment will be described with reference to a flow chart shown in FIG. 13. FIG. 13 is the flow chart illustrating procedures of a slot game processing executed by the CPU 106 shown in FIG. 5 according to the game execution programs stored in the ROM 108.

First, the CPU 106 determines whether or not a credit(s) have been bet in step S11 upon starting the slot game processing shown in FIG. 13. In this processing, the CPU 106 determines whether or not it has received either a signal output from the bet switch 25 upon the bet switch 25 being pressed or a signal output from the max-bet switch 24 upon the max-bet switch 24 being pressed. If it is determined that no credit has been bet, the process flow is returned to step S11.

On the other hand, if it is determined in step S11 that a credit(s) has been bet, the CPU 106 reduces a credit amount stored in RAM 110 according to a credit amount had been bet in step S12.

Next, the CPU 106 determines whether or not the start switch 27 has been pressed in step S14. In this processing, the CPU 106 determines whether or not a signal has been received, which is output from the start switch 27 when the start switch 27 is pressed.

If it is determined that the start switch 27 has not been pressed, the CPU 106 returns the process flow to step S11. Note that, if the start switch 27 has not been pressed (for example, a command for finishing a game has been input instead of pressing the start switch 27), the CPU 106 cancels the reducing result of the credit amount in step S12.

If it is determined that the start switch 27 has been pressed in step S13, the process flow proceeds from step S13 to step S14 and then the CPU 106 determines which symbols are to be stopped. In this stop symbol determination process, the CPU 106 determines the stop symbols to be displayed (rearranged) in the segmented areas q11 to q53 by executing a stop symbol determination program which is one of the game execution programs stored in the ROM 108.

In this process, the CPU 106 selects random number values among numeric values “0-255” for the segmented areas q11 to q53, respectively, by executing a random number generating program in order to determine the stop symbols for the segmented areas q11 to q53 by referring to respective correspondence between the random number values and the symbol stored in the ROM 108.

Subsequently, the CPU 106 executes a determination process of contents to be displayed on the bubble display 17 in step S15. In this process, the CPU 106 determines the contents of the bubble image to be displayed on the bubble display 17 according to the content of the stop symbols determined in step S14.

Note that, if the symbols determined in step S14 are to form a pattern that brings a winning combination(s) on an activated payline(s), it is determined in step S15 that the belt-like bubble image as previously described with reference to FIGS. 6 to 12 is to be displayed on the bubble display 17. If the symbols determined in step S14 are not to form a pattern that brings a winning combination on an activated payline, it is determined in step S15 that no bubble image is to be displayed on the bubble display 17.

Next, the CPU 106 executes a display process in step S16. In this process, the stop symbols determined in step S14 are displayed (rearrange) in the segmented areas q11 to q53 on the LCD 16. In addition, in case where it has been determined in step S15 to display the bubble image on the bubble display 17, a process for displaying the determined image on the bubble display 17 is executed in synchronization with the process for displaying (rearranging) the stop symbols on the LCD 16.

After the display process has been finished, the process flow proceeds to step S17 and then the CPU 106 executes a payout confirmation process. In this process, it is determined whether or not the symbols rearranged on the segmented areas q11 to q53 has formed a pattern that brings a winning combination(s) on an activated payline(s).

In step S18, the CPU 106 executes a payout process for providing a payout of credits according to the result of the payout confirmation process in step S17. In this payout process, the CPU 106 adds credits according to a payout amount preliminarily defined in a payout table stored in the ROM 108 to the credit amount stored in the RAM 110. After this payout process, the process flow is returned to step S11 and a next slot game will be executed.

With the slot machine 10 according to the first embodiment,
the belt-like bubble image for preintimating an achievement of a winning combination as shown in FIGS. 6 to 12 displayed on the bubble display 17 in synchronization with symbol rearrangement in the segmented areas q11 to q53 by the CPU 106 executing the above-described slot game processing in a slot game, for example, in which a winning combination with all bell symbols is to be achieved on an activated upper payline as shown in FIG. 14.

In this case, a player can transmissively view rearranging(ed) symbols on the LCD 16 behind the tubes 17a1 to 17e6 and the liquids 14a1 to 14e6 of the bubble display 17 under a condition in which bubbles are generated and displayed in the tubes 17a1 to 17e6 of the bubble display 17 by opening the air on-off valves 32a1 to 32e6 or a condition in which bubbles are not generated nor displayed in the tubes 17a1 to 17e6 of the bubble display 17 by closing the air on-off valves 32a1 to 32e6.

Therefore, visibility degradation of symbols displayed on the LCD 16 due to existence of the bubble display 17 can be prevented, even if a bubble image cannot be displayed on the bubble display 17 due to an electrical outage or a malfunction of the bubble display 17, the air on-off valve drive circuit 42, the controller 40 or the like or even if a bubble image is displayed on the bubble display 17 without a break with the air on-off valves 32a1 to 32e6 being kept open.

In case where an overlaid image over symbols to be viewed by a player is displayed on a transmissive display such as an LCD or an organic EL (electroluminescent) display disposed in front of the LCD 16 displaying the symbols thereon, consideration should be required for securing visibility of the image, for example, displaying the image on the transmissive display with higher brightness than ambient lighting around the slot machine. In addition, in case where an LCD is applied as the transmissive display, it may happen that a view field is obstructed by the LCD when viewing the symbols from an offset position from its front center. Furthermore, symbols on the reels cannot be viewed in case of an electrical outrage or a device malfunction if elements capable of being transmissive during no electrical supply is not be employed such as in a normally transmissive type LCD. However, the above issues can be solved completely by employing the bubble display 17 instead of the transmissive display.

Note that a bubble image of a term “BONUS” shown in FIG. 14 for preintimating an achievement of a winning combination can be displayed on the bubble display 17 instead of the belt-like bubble image shown in FIGS. 6 to 12.

Next, a slot machine according to a second embodiment of the present invention will be described. The slot machine according to the second embodiment has a configuration in which the transparent and colorless liquid 14a1 to 14e6 of the first embodiment may be colorized by injection of color-changer and returned to the original transparent and colorless state by injection of neutralizer.

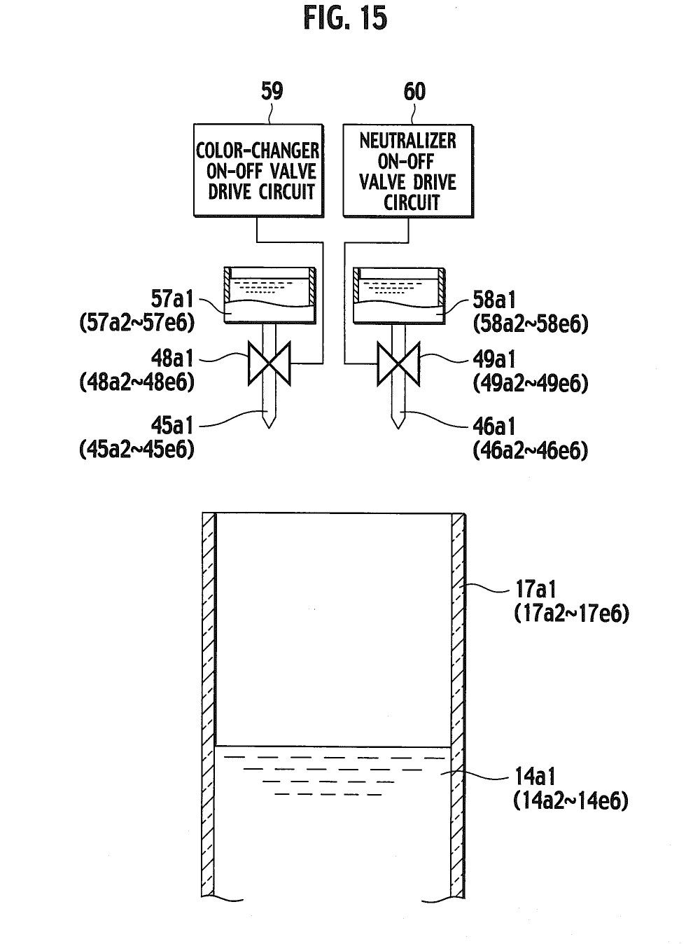

Specifically, as shown in FIG. 15, color-changer injection nozzles 45a1 to 45e6 (corresponding to a plurality of first nozzles in the claims) and neutralizer injection nozzles 46a1 to 46e6 (corresponding to a plurality of second nozzles in the claims) are provided above the tubes 17a1 to 17e6 of the bubble display 17, respectively. The color-changer injection nozzles 45a1 to 45e6 are connected to color-changer tanks 57a1 to 57e6 via color-changer on-off valves 48a1 to 48e6 (corresponding to a plurality of first on-off valves in the claims). The neutralizer injection nozzles 46a1 to 46e6 are connected to neutralizer tanks 60a1 to 60e6 via neutralizer on-off valves 49a1 to 49e6 (corresponding to a plurality of second on-off valves in the claims).

In the slot machine according to the second embodiment, transparent and colorless solution (indicator phenolphthalein is mixed into pure water of pH 7) is used as the liquids 14a1 to 14e6. In addition, strongly basic solution such as aqueous sodium hydroxide is reserved in the color-changer tanks 57a1 to 57e6 as the color-changer. Furthermore, strong acid solution such as hydrochloric acid solution is reserved in the neutralizer tanks 60a1 to 60e6 as the neutralizer.

The color-changer on-off valves 48a1 to 48e6 are normally in their closed state and kept open for a certain period by the color-changer on-off valve drive circuit 59. By opening the color-changer on-off valves 48a1 to 48e6 once, the pH of the liquids 14a1 to 14e6 changes from 7 near to alkaline 10. As a result, the liquids 14a1 to 14e6 alkalified near to pH 10 are colorized from transparent and colorless to deep pink.

The neutralizer on-off valves 49a1-49e6 are normally in their closed state and kept open for a certain period by the neutralizer on-off valve drive circuit 60. By opening the neutralizer on-off valves 49a1-49e6 once, the liquids 14a1 to 14e6 alkalified near to pH 10 are neutralized near to its original pH 7. As a result, the liquids 14a1 to 14e6 being colored in deep pink is returned to its original transparent and colorless state.

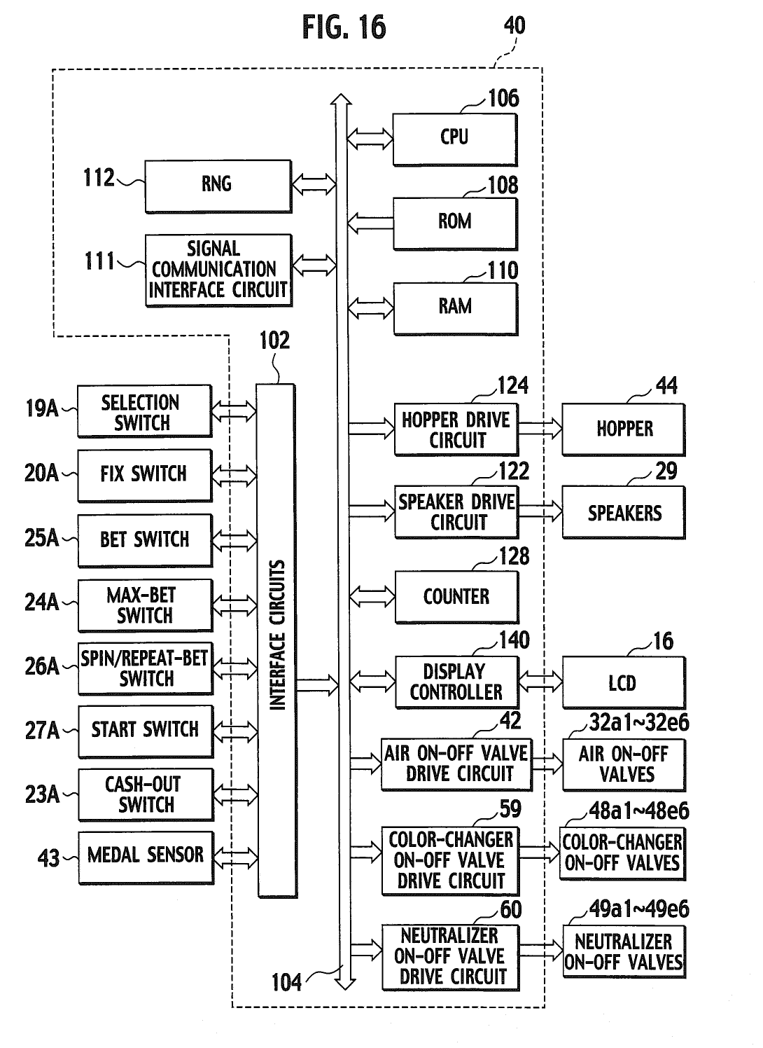

Opening and closing of the color-changer on-off valves 48a1 to 48e6 by the above-mentioned color-changer on-off valve drive circuit 59 and opening and closing of the neutralizer on-off valves 49a1 to 49e6 by the neutralizer on-off valve drive circuit 60 are controlled by the controller 40 shown in FIG. 16. The procedure of the slot game processing executed by the CPU 106 of the controller 40 is basically the same as the procedure of the slot game processing of the first embodiment shown in FIG. 13. However, image contents determined to be displayed on the bubble display 17 in step S15 and a specific process of the display process executed in step S16 are different from the procedure of the slot game processing of the first embodiment.

First, if symbols determined in step S14 are to form a pattern in which at least one specific symbol is to be rearranged on an activated payline, the CPU 106 determines, in step S15, the image contents to be displayed on the bubble display 17 as described hereinafter. Note that the specific symbol is a symbol that brings a specific winning combination triggering a jackpot, for example.

Specifically in this case, a process is executed, in which the liquids 14a1 to 14e6 are made alkaline near to pH 10 and colorized into deep pink in a display process of next step S16 by opening the color-changer on-off valves 48a1 to 48e6 once to inject the color-changer stored within the color-changer tanks 57a1 to 57e6 into the neutral liquids 14a1 to 14e6 filled in the tubes 17a1 to 17e6.

Next, as with the first embodiment, a process is executed to display a belt-like bubble image on the bubble display 17 similarly to the process described with reference to FIGS. 6 to 12 in the first embodiment. In synchronization with this process, a process is executed to display (rearrange) the stop symbols determined in step S14 in the segmented areas q11 to q53 on the LCD 16.

Finally, after displaying the belt-like bubble image on the bubble display 17 has been finished, executed is a process in which the liquids 14a1 to 14e6 are returned from deep pink to transparent and colorless by opening the neutralizer on-off valves 49a1 to 49e6 once to neutralize the liquids 14a1 to 14e6 to inject the neutralizer stored within the neutralizer tanks 58a1 to 58e6 into the alkaline liquids 14a1 to 14e6 filled in the tubes 17a1 to 17e6.

Note that, the above-mentioned specific symbol shall be a pink symbol in the slot machine according to the second embodiment. Symbols displayed behind are masked by bubbles injected into the liquids 14a1 to 14e6 in the slot machine according to the first embodiment. However, a player can view symbols displayed behind through bubbles injected into the liquids 14a1 to 14e6 in the slot machine according to the second embodiment. Therefore, the bubbles injected into the liquids 14a1 to 14e6 by the air on-off valves 32a1 to 32e6 shall be sufficiently large to allow the symbols displayed behind to be viewed therethrough.

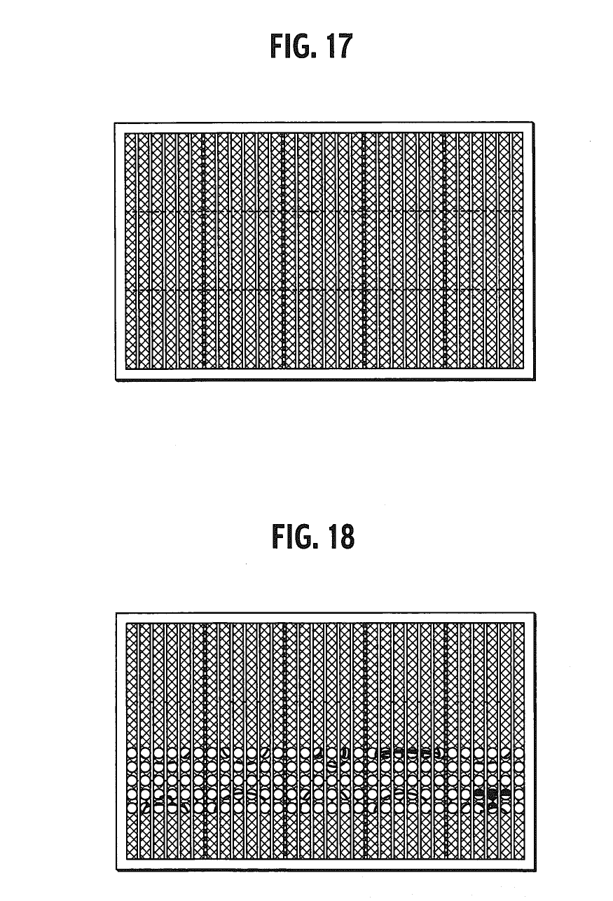

In the slot machine according to the second embodiment in which the CPU 106 executes the above slot game processing, the liquids 14a1 to 14e6 of the bubble display 17 are firstly colorized into deep pink as shown in FIG. 17 after start of symbol scrolling on the LCD 16 in case where at least one specific symbol is to be rearranged on an activated payline. As a result, the specific pink symbol among scrolling symbols is masked by the liquids 14a1 to 14e6 and then a player cannot view it. In addition to the specific symbol, it becomes difficult for the player to view a reddish symbol(s) whose color has a wavelength close to a wavelength of pink due to the liquids 14a1 to 14e6.

Next to such a situation, the stop symbols are displayed (rearranged) in the segmented areas q11 to q53 in a pattern in which the at least one specific symbol is rearranged on the activated payline. Simultaneously, a belt-like bubble image for preintimating rearrangement of the specific symbol on an activated payline is displayed on the bubble display 17 as similarly shown in FIGS. 6 to 12. Therefore, brought is a situation in which the symbols displayed behind the belt-like bubbles can be clearly viewed through the transparent tubes 17a1 to 17e6 and the transparent bubbles in the colorized pink liquids 14a1 to 14e6 as shown in FIG. 18.

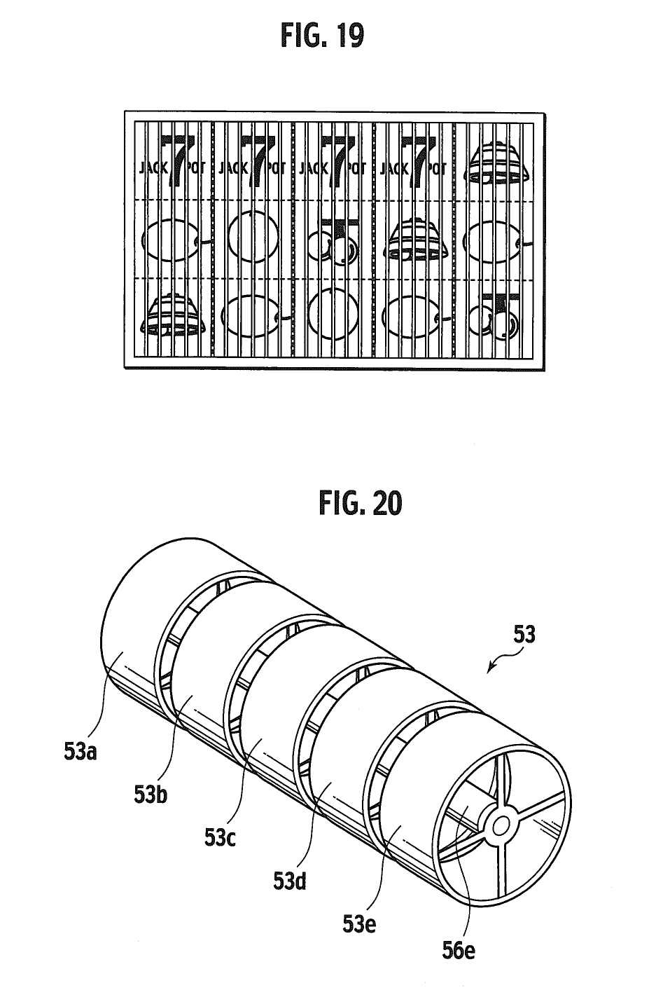

Then, after displaying the belt-like bubble image on the bubble display 17 has been finished, the liquids 14a1 to 14e6 of the bubble display 17 are returned from deep pink to transparent and colorless as shown in FIG. 19. As a result, brought is a situation in which all the stop symbols displayed in the segmented areas q11 to q53 can be clearly viewed through the transparent tubes 17a1 to 17e6 and the liquids 14a1 to 14e6 which have been returned to transparent and colorless.

In the slot machine according to the second embodiment as configured above with the liquids 14a1 to 14e6 in the tubes 17a1 to 17e6 being transparent and colorless, visibility degradation of symbols displayed on the LCD 16 due to existence of the bubble display 17 can be prevented, even if a bubble image cannot be displayed on the bubble display 17 due to an electrical outage or a malfunction of the bubble display 17, the air on-off valve drive circuit 42, the controller 40 or the like or even if a bubble image is displayed on the bubble display 17 without a break with the air on-off valves 32a1 to 32e6 being kept open.

In addition, according to the second embodiment with the liquids 14a1 to 14e6 in the tubes 17a1 to 17e6 being colorized into deep pink, the same advantages as described above can be achieved even if a bubble image is displayed on the bubble display 17 without a break with the air on-off valves 32a1 to 32e6 being kept open.

Note that, in the first and second embodiments, the LCD 16 is provided behind the bubble display 17 and displays symbol rearrangement in the segmented areas q11 to q53 thereon.

However, employed can be a configuration in which five spinning reels 53a to 53e corresponding to respective columns with symbols on their circumferential surfaces are provided behind the bubble display 17 instead of the LCD 16 to rearrange the symbols in the segmented areas q11 to q53, as in a slot machine according to a third embodiment of the present invention shown in FIG. 20.

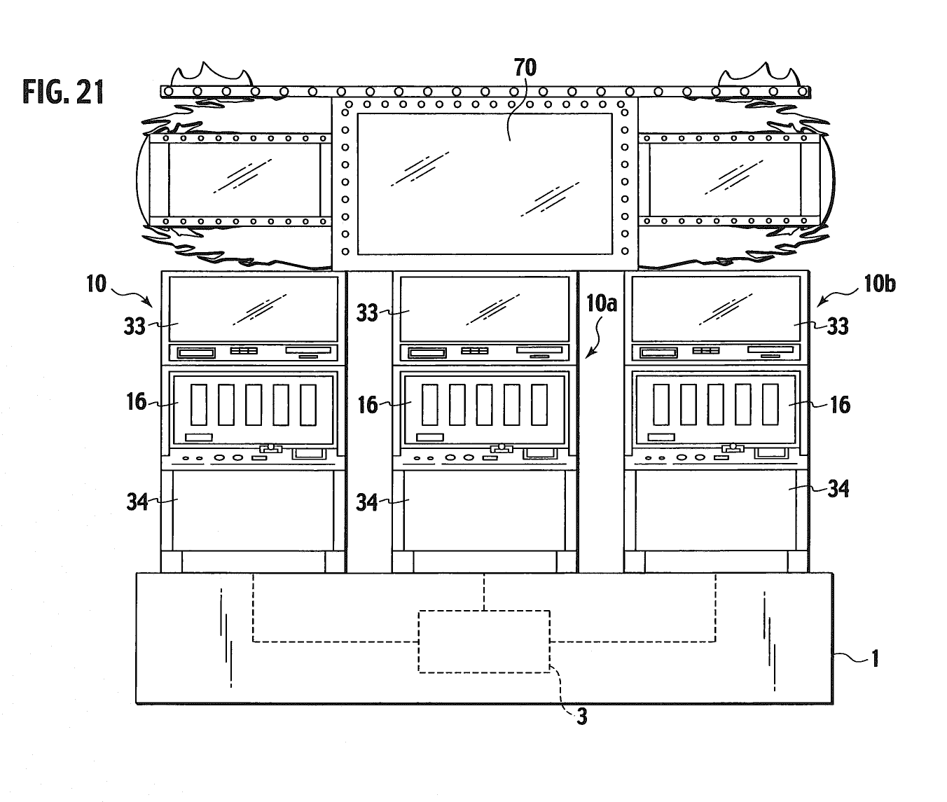

Next, a fourth embodiment of the present invention will be described. The fourth embodiment of the present invention provides a configuration of a slot machine system which shares a progressive jackpot bonus among three slot machines 10, 10a and 10b installed on a single stage 1 as shown in FIG. 21. Some of credits had been bet on each of the slot machines 10, 10a and 10b are appropriated as a progressive jackpot bonus fund. In the following description, the progressive jackpot bonus will be referred to as the progressive bonus.

If a winning combination which awards a progressive bonus payout has been achieved at any of the slot machines 10, 10a and 10b under a condition in which the progressive bonus fund counted by a controller 3 provided on the stage 1 is equal-to or more-than a reference value, the progressive bonus determined according to a prescribed rule is awarded by the controller 3.

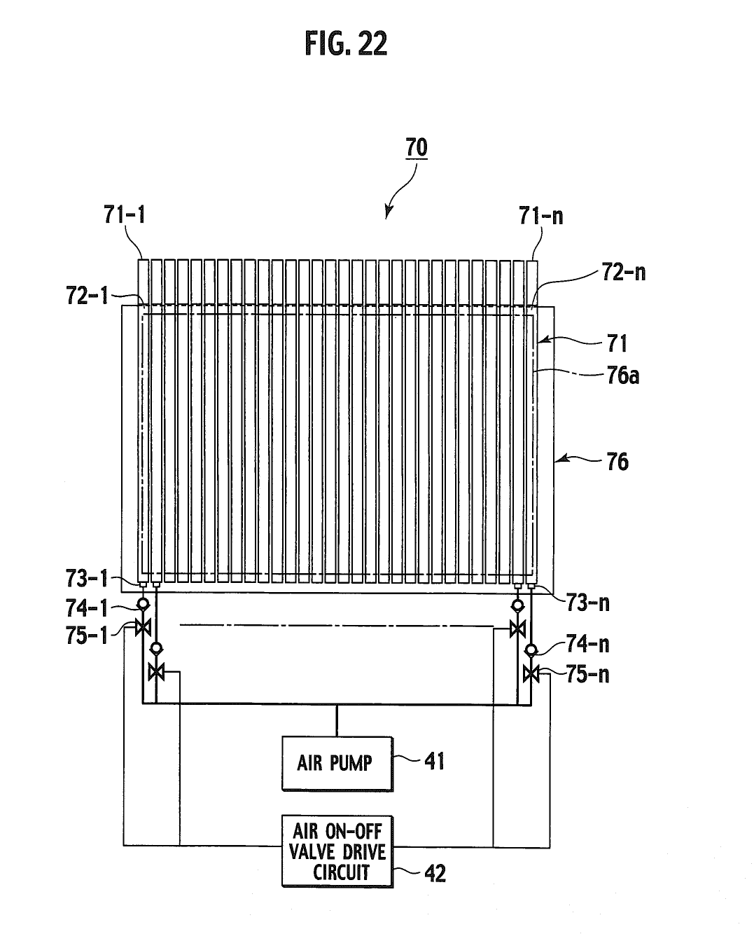

A variety of information relating to a progressive bonus is displayed on a communal display unit 70 (corresponding to a display system in the claims) provided above the three slot machines 10, 10a and 10b by the controller 3. As shown in FIG. 22, the communal display unit 70 includes an LED display 76 (corresponding to a rear display in the claims) and a bubble display 71 (corresponding to the front display in the claims) provided in front of the LED display 76.

The LED display 76 is configured with a large number of LEDs provided in a matrix arrangement. The LED display 76 has a display area 76a. The display area 76a has a size capable of displaying a plurality of characters such as letters or symbols in both a column direction extending laterally in FIG. 22 and a row direction extending vertically. The LED display 76A displays accumulated credits of the progressive bonus fund in the display area 76a as a bonus value. In addition, the LED display 76 displays a payout amount history of the past progressive bonuses in the display area 76a.

The bubble display 71 provided in front of the LED display 76 has plural transparent elongated tubes 71-1 to 71-n, bubble generating nozzles 73-1 to 73-n respectively corresponding to the tubes 71-1 to 71-n, check valves 74-1 to 74-n, air on-off valves 75-1 to 75-n and an air pump 41.

Each of the tubes 71-1 to 71-n has a hollow shape being penetrated in its longitudinal direction. The longitudinal direction of the tubes 71-1 to 71-n coincides with a vertical direction of the display area 76a of the LED display 76. In other words, the tubes 71-1 to 71-n are aligned along a lateral direction of the display area 76a.

Each upper end of the tubes 71-1 to 71-n is open, and each inside of the tubes 71-1 to 71-n is filled with transparent and colorless liquid 72-1 to 72-n up to a position slightly lower than each upper end of the tubes 71-1 to 71-n.

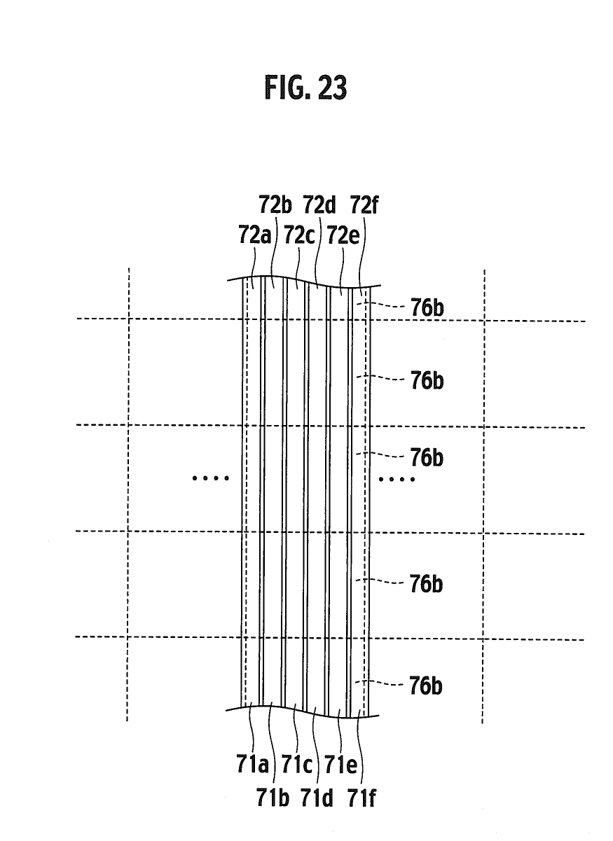

As schematically shown in FIG. 23, the display segments 76b, each of which is sized to a single character, aligned in the vertical direction of the display area 76a on the LED display 76 are covered by the liquids 72a to 72f in the six tubes 71a to 71f.

As shown in FIG. 22, each of the bubble generating nozzles 73-1 to 73-n is connected to each corresponding bottom (lower end) of the tubes 71-1 to 71-n. Each of the air on-off valves 75-1 to 75-n is connected to each of the bubble generating nozzles 73-1 to 73-n, via each of the check valves 74-1 to 74-n. The liquids 72-1 to 72-n in the tubes 71-1 to 71-n do not flow into the air on-off valves 75-1 to 75-n through the check valves 74-1 to 74-n.

The air on-off valves 75-1 to 75-n are connected to the air pump 41. In addition, opening and closing of each of the air on-off valves 75-1 to 75-n is driven by an air on-off valve drive circuit 42. Air supplied from the air pump 41 is sent into each of the bubble generating nozzles 73-1 to 73-n through each of the check valves 74-1 to 74-n while the air on-off valves 75-1 to 75-n are made open.

The bubble generating nozzles 73-1 to 73-n diffuse the air supplied from the air pump 41 into bubbles and inject them into the liquids 72-1 to 72-n of the corresponding tubes 71-1 to 71-n. The injected bubbles float upward in the liquids 72-1 to 72-n in the tubes 71-1 to 71-n. The liquids 72-1 to 72-n never overflow from the tubes 71-1 to 71-n due to rises of liquid levels by injection of the bubbles.

Note that the bubble generating nozzles 73-1 to 73-n can be configured similarly to the bubble generating nozzles 30a1 to 30e6 in the bubble display 17 of the first embodiment.

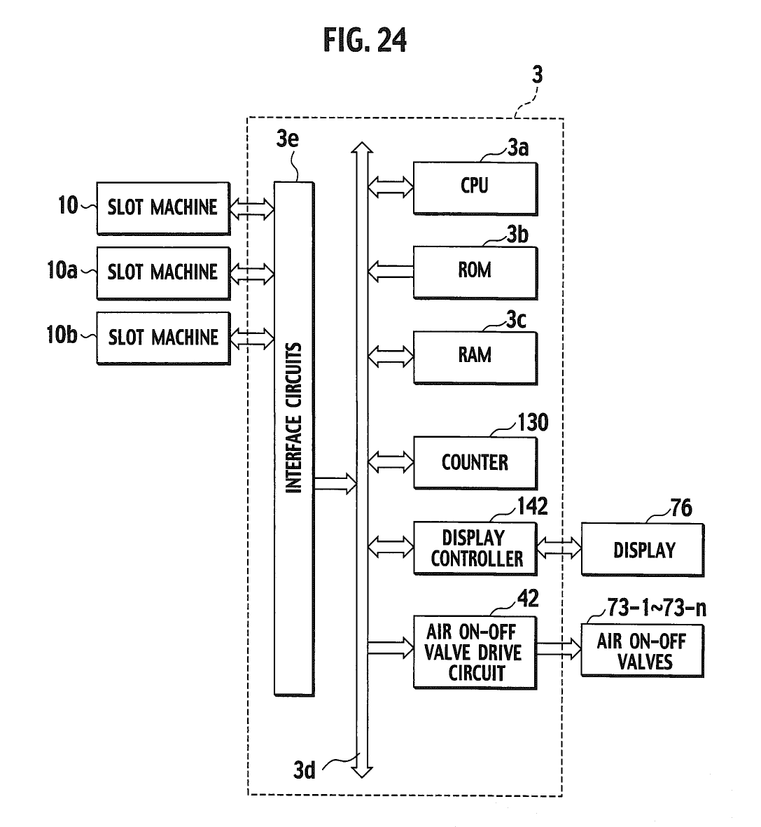

In the communal display unit 70 of the slot machine system according to the fourth embodiment, opening and closing of the air on-off valves 75-1 to 75-n are driven by the air on-off valve drive circuit 42 in a pattern according to a predetermined image corresponding to characters to be displayed in the display area 76a on the LED display 76. Opening and closing drive of the air on-off valves 75-1 to 75-1 by the air on-off valve drive circuit 42 is controlled by the controller 3 shown in FIG. 24.

The controller 3 is a microcomputer and includes interface circuits 3e, an I/O bus 3d, a CPU 3a, a ROM 3b, a RAM 3c, a counter 130, a display controller 142 and the above-mentioned air on-off valve drive circuit 42 (see FIG. 22).

The interface circuits 3e are connected to the I/O bus 3d and the I/O bus 3d transmits data signals or address signals with the CPU 3a.

The three slot machines 10, 10a and 10b on the stage 1 are connected to the interface circuits 3e. Each of the slot machines 10, 10a and 10b output a signal of a credit amount bet on a slot game to be accumulated as the progressive bonus fund or the like. The output signal is transmitted to the CPU 3a via the I/O bus 3d after having been converted into a predetermined signal in the interface circuits 3e.

The ROM 3b for storing system programs and the RAM 3c for storing a variety of data are connected to the I/O bus 3d. Furthermore, the display controller 142, the counter 130 and the air on-off valve drive circuit 42 are connected to the I/O bus 3d.

The CPU 3a reads out a display program stored in the ROM 3b to execute a presentation on the communal display unit 70. The display execution program is a program for executing a slot game on the LCD 16 via the display controller 142.

The counter 130 functions to count the progressive bonus fund.

Upon betting credits on a slot game at any of the slot machines 10, 10a and 10b, the progressive bonus fund counted by the counter 130 is increased by some of the credits. Note that the counter 130 can be implemented within the RAM 3c.

The air on-off valve drive circuit 42 controls the bubble display 71 with respect to a display control executed on the communal display unit 70. Specifically, the CPU 3a generates an image display command signal according to contents to be displayed in the display area 76a on the LED display 76 and outputs the image display command signal to the air on-off valve drive circuit 42 via the I/O bus 3d. The air on-off valve drive circuit 42 generates a drive signal for driving the bubble display 71 of the communal display unit 70 based on the image display command to output the generated drive signal to respective air on-off valves 75-1 to 75-n of the bubble display 71 upon receiving the image display command signal from the CPU 3a.

The display controller 142 controls the LED display 76 with respect to the display control executed on the communal display unit 70. Specifically, the CPU 3a generates the image display command signal according to the contents to be displayed in the display area 76a of the LED display 76 and outputs the image display command signal to the display controller 142 via the I/O bus 3d. The display controller 142 generates a drive signal for driving the LED display 76 of the communal display unit 70 based on the image display command to output the generated drive signal to the LED display 76 upon receiving the image display command signal from the CPU 3a.

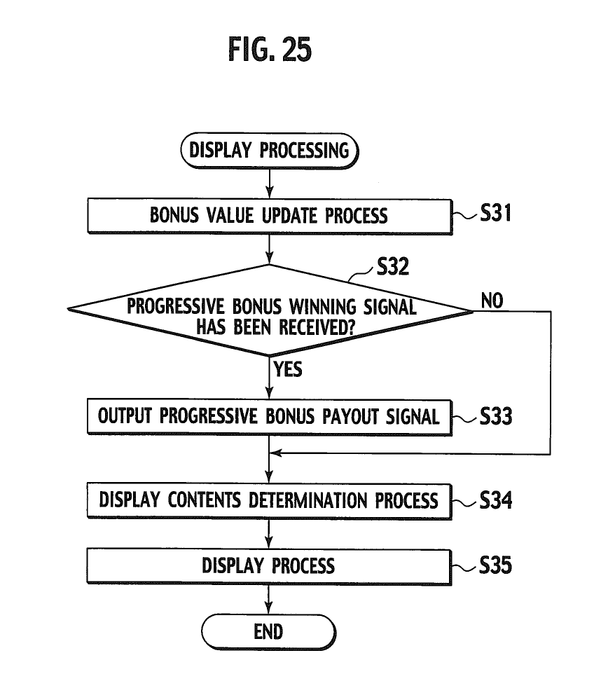

Next, processing procedures of a progressive bonus presentation on the communal display unit 70 of the slot machine system in the fourth embodiment according to the present invention will be described with reference to a flow chart shown in FIG. 25.

In step S31, the CPU 3a first executes an update process of a progressive bonus value. In the bonus value update process, the CPU 3a receives signals of credit amounts bet on slot games from the slot machines 10, 10a and 10b and accumulates some of the credit amounts of the received signals into the count value in the counter 130 for counting the progressive bonus fund.

Next in step S32, the CPU 3a determines whether or not a signal of a winning combination achievement for awarding a progressive bonus payout has been received from any of the slot machines 10, 10a or 10b. If it has not received (NO in step S32), the process flow proceeds to step S34 described below. If it has been received (YES in step S32), a payout signal command of the progressive bonus is output to the slot machine(s) 10, 10a and 10b that sent the signal (step S33). Subsequently, the process flow proceeds to step S34.

In step S34, the CPU 3a executes a determination process of the contents to be displayed on the communal display unit 70. In this process, the CPU 3a determines to display a notifying message for awarding a progressive bonus in the display area 76a on the LED display 76 when having received the signal of a winning combination achievement for awarding a progressive bonus payout from any of the slot machines 10, 10a or 10b in step S32. Otherwise, the CPU 3a determines to display the progressive bonus value (count value of the counter 130) updated in step S31, a payout history of the progressive bonus or the like in the display area 76a on the LED display 76.

Additionally in step S34, the CPU 3a determines to display a message by a bubble image for notifying that a progressive bonus has not yet been awarded on the bubble display 71 when not having received the signal of a winning combination achievement for awarding a progressive bonus payout from any of the slot machines 10, 10a or 10b in step S32.

Next in step S35, the CPU 3a executes a display process. In this process, the contents determined in step S34 are displayed in the display area 76a on the LED display 76. In addition, in case where it has been determined to display the bubble image on the bubble display 71 in step S34, the image determined is displayed on the bubble display 71 in synchronization with the display process of the message or the like in the display area 76a on the LED display 76.

The process flow returns to the above-mentioned step S31 after the display process has been completed and thereby the CPU 3a executes the next display processing.

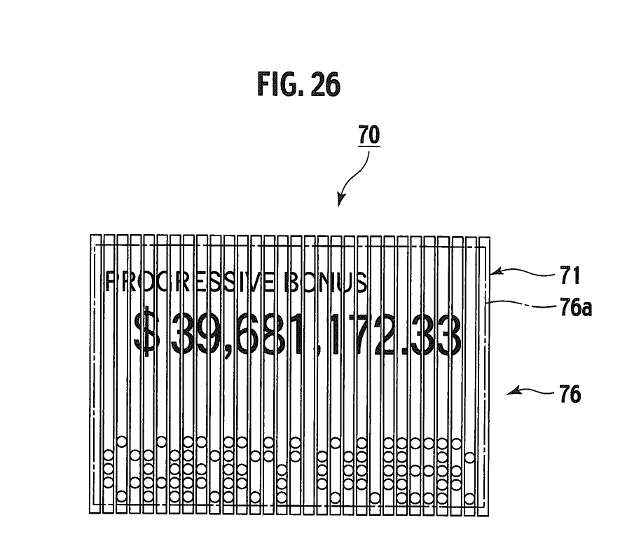

In the slot machine system according to the fourth embodiment, for example, an image of the progressive bonus value is displayed in the display area 76a on the LED display 76 as shown in FIG. 26 and a bubble image of a message “CARRY OVER” for notifying that a progressive bonus has not yet been awarded is displayed on the bubble display 71 by an execution of the above-mentioned slot game processing by the CPU 3a.

In this case, players at the slot machines 10, 10a and 10b and spectators around the slot machine system can view a presentation on the LED display 76 provided behind the bubble display 71 through the tubes 71-1 to 71-n and the liquids 72-1 to 72-n thereof under a condition in which bubbles are generated and displayed in the tubes 71-1 to 71-n of the bubble display 71 by opening the air on-off valves 75-1 to 75-n or a condition in which bubbles are not generated nor displayed in the tubes 71-1 to 71-n of the bubble display 71 by closing the air on-off valves 75-1 to 75-n.

Therefore, visibility degradation of symbols displayed on the LED display 76 due to existence of the bubble display 71 can be prevented, even if a bubble image cannot be displayed on the bubble display 71 due to an electrical outrage or a malfunction of the bubble display 71, the air on-off valve drive circuit 42, the controller 3 or the like or even if a bubble image is displayed on the bubble display 71 without a break with the air on-off valves 75-1 to 75-n being kept open.

Namely, in case where an overlaid image over a bonus value or the like to be viewed by spectators is displayed on a transmissive display such as an LCD or an organic EL (electroluminescent) display disposed in front of the LED display 76 displaying the progressive bonus value or the like, consideration should be required for securing visibility of the image, for example, displaying the image on the transmissive display with higher brightness than ambient lighting around the slot machine system.

In addition, in case where an LCD is applied as the transmissive display, it may happen that a view field is obstructed by the LCD when viewing a presentation on the LED display 76 from an offset position from its front center.

Furthermore, in case where an transmissive display is applied, an presentation on the LED display 76 cannot be viewed in case of an electrical outrage or a device malfunction if elements capable of being transmissive during no electrical supply is not be employed such as in a normally transmissive type LCD. However, all the above issues can be solved completely by employing the bubble display 71 instead of the transmissive display.

Although a display system of the present invention has been described based on the illustrated embodiments, the present invention is not limited the above, and the arrangement of respective components can be replaced by any of those having a similar functionality.

For example, although an example has been described wherein the fifteen segmented areas q11 to q53 are provided on the LCD 16 and a slot game is executed in the segmented areas q11 to q53 in the above-mentioned embodiments, the present invention is not limited to this. A variety of display areas can be adopted such as three rows and three columns display areas or the like.

In addition, in the foregoing detail description, the characteristic portions of the present invention have been mainly described in order to make the present invention easily understandable. The present invention is not limited to the embodiments described above in the foregoing detail description, and can be applied to other embodiments, and its applicable range is wide. Moreover, the terms and the terminology used in the present specification are used for the purpose of precisely explaining the present invention, and not used for the purpose of limiting interpretations of the present invention. Further, it should be easy for those skilled in the art to contemplate other configurations, systems, methods, etc., which are included in the concept of the present invention, from the concept of the present invention described in the present specification. For this reason, the description of the appended claims must be construed as containing equivalent configurations within a range of not departing from a range of the technical ideas of the present invention. Moreover, the abstract aims to allow the United States Patent and Trademark Office, general public office, and engineers who are not familiar with a patent, legal terms and technical terms, and who pertain to the technical field of the present invention, to quickly judge the technical content and essence of the present application with a simple study. Accordingly, the abstract is not intended to limit the scope of the invention that should be assessed from the description of the appended claims. Furthermore, it is desirable that the present invention be interpreted by fully taking already-disclosed literatures and the like into consideration in order to fully understand the object of the present invention and unique effects of the present invention.

The forgoing detail descriptions include the processing executed by the computer. The above descriptions and expressions are described in order for those skilled in the art to understand the present invention in the most efficiently. In this specification, each step used for deriving one result should be understood as a processing without a self-contradiction. Moreover, in each step, a transmission, reception, storage, etc., of an electric or magnetic signal is performed. A bit, value, symbol, letter, term, number and the like are used to express such signals in the processing in each step, but it should be noted that these are simply used to make the explanation easy. In addition, the processing at each step is sometimes described in an expression in common with human activities, but the processings described in this specification are principally executed by various types of devices. Furthermore, another configuration required for executing each step is obvious from the foregoing descriptions.

What is claimed is:

1. A display system comprising:
a rear display capable of displaying a plurality of symbols laterally;
a front display provided in front of the rear display and including:
(a) a plurality of transparent tubes extending vertically and aligned laterally,
(b) liquids filled in the plural of tubes, respectively, and
(c) a plurality of bubble generating nozzles provided at bottoms of the tubes, respectively, for generating bubbles to emerge in the liquids in the plurality of tubes, respectively;
a plurality of air on-off valves connected to the plurality of bubble generating nozzles, respectively;
an air pump connected to each of the plurality of air on-off valves; and
a controller operable to control opening and closing of the plurality of air on-off valves, respectively, in a pattern according to a prescribed image that is displayed on the front display by the bubbles in the liquids in the plurality of tubes and associated with contents of the plurality of symbols displayed on the rear display.

2. The display system according to claim 1, wherein the prescribed image includes a message associated with the contents of the plurality of symbols displayed on the rear display.

3. The display system according to claim 1, wherein
the front display further includes
a plurality of first nozzles provided at the plurality of tubes, respectively, for injecting color-changer into the liquids in the plurality of tubes, respectively,
a plurality of second nozzles for provided at the plurality of tubes, respectively, for injecting neutralizer of the color-changer into the liquids in the plurality of tubes, respectively,
a plurality of first on-off valves connected to the plurality of first nozzles, respectively, and
a plurality of second on-off valves connected to the plurality of second nozzles, respectively,
the liquids are transparent and colorless at equilibrium, and
the controller is further operable to control opening and closing of the plurality of first and second on-off valves, respectively, in the pattern associated with colors of the prescribed image.

4. A display system comprising:
a rear display capable of shifting vertically and stopping a plurality of symbols aligned laterally to rearrange the symbols had been arranged thereon;
a front display provided in front of the rear display and including:
(a) a plurality of transparent tubes extending vertically and aligned laterally,
(b) liquids filled in the plural of tubes, respectively, and
(c) a plurality of bubble generating nozzles provided at bottoms of the tubes, respectively, for generating bubbles to emerge in the liquids in the plurality of tubes, respectively;
a plurality of air on-off valves connected to the plurality of bubble generating nozzles, respectively;
an air pump connected to each of the plurality of air on-off valves; and
a controller operable to control opening and closing of the plurality of air on-off valves, respectively, in a pattern according to a prescribed image that is displayed on the front display by the bubbles in the liquids in the plurality of tubes and associated with contents of the plurality of symbols rearranged on the rear display.

5. The display system according to claim 4, wherein
the prescribed image includes a message associated with the contents of the plurality of symbols rearranged on the rear display.

6. The display system according to claim 4, wherein
the front display further includes
a plurality of first nozzles provided at the plurality of tubes, respectively, for injecting color-changer into the liquids in the plurality of tubes, respectively,
a plurality of second nozzles for provided at the plurality of tubes, respectively, for injecting neutralizer of the color-changer into the liquids in the plurality of tubes, respectively,
a plurality of first on-off valves connected to the plurality of first nozzles, respectively, and
a plurality of second on-off valves connected to the plurality of second nozzles, respectively,
the liquids are transparent and colorless at equilibrium, and
the controller is further operable to control opening and closing of the plurality of first and second on-off valves, respectively, in the pattern associated with colors of the prescribed image.

7. A display system comprising:
a rear display capable of displaying information on a progressive bonus using a plurality of symbols aligned laterally thereon, some of a credit amount that had been bet on a unit game at each of a plurality of slot game machines being accumulated for the progressive bonus;
a front display provided in front of the rear display and including:
(a) a plurality of transparent tubes extending vertically and aligned laterally,
(b) liquids filled in the plural of tubes, respectively, and
(c) a plurality of bubble generating nozzles provided at bottoms of the tubes, respectively, for generating bubbles to emerge in the liquids in the plurality of tubes, respectively;
a plurality of air on-off valves connected to the plurality of bubble generating nozzles, respectively;
an air pump connected to each of the plurality of air on-off valves; and
a controller operable to control opening and closing of the plurality of air on-off valves, respectively, in a pattern according to a prescribed image that is displayed on the front display by the bubbles in the liquids in the plurality of tubes and associated with contents of the information displayed on the rear display.

8. The display system according to claim 7, wherein
the prescribed image includes a message associated with the contents of the information displayed on the rear display.

9. The display system according to claim 7, wherein
the front display further includes
a plurality of first nozzles provided at the plurality of tubes, respectively, for injecting color-changer into the liquids in the plurality of tubes, respectively,
a plurality of second nozzles for provided at the plurality of tubes, respectively, for injecting neutralizer of the color-changer into the liquids in the plurality of tubes, respectively,
a plurality of first on-off valves connected to the plurality of first nozzles, respectively, and
a plurality of second on-off valves connected to the plurality of second nozzles, respectively,
the liquids are transparent and colorless at equilibrium, and
the controller is further operable to control opening and closing of the plurality of first and second on-off valves, respectively, in the pattern associated with colors of the prescribed image.
